(19) United States
(12) Patent Application Publication
(10) Pub. No.: US 2015/0092385 A1
(43) Pub. Date: Apr. 2, 2015

(54) DISPLAY APPARATUS

(71) Applicant: Samsung Display Co., LTD., Yongin-City (KR)

(72) Inventors: In-Su BAEK, Seoul (KR); Hee-Sung LIM, Seoul (KR); Yong-Woo KIM, Seoul (KR); Jae-Hwan JEON, Seoul (KR)

(73) Assignee: Samsung Display Co., LTD., Yongin-City (KR)

(21) Appl. No.: 14/187,607

(22) Filed: Feb. 24, 2014

(30) Foreign Application Priority Data
Oct. 1, 2013 (KR) 10-2013-0117193

(51) Int. Cl. G02F 1/1335; F21V 8/00

(52) U.S. Cl. CPC G02F 1/133528; G02B 6/0055; G02B 6/0053
USPC 362/19

(57) ABSTRACT

A display apparatus includes a display panel which displays an image, a polarizing member including a first polarizing film on a lower surface of the display panel and a second polarizing film on an upper surface of the display panel, a light guide plate which receives the display panel and is adhered to the first polarizing film, and a reflecting sheet extending from a lower surface of the light guide plate to the upper surface of the display panel and covering the light guide plate and a portion of the display panel.

This application claims priority to Korean Patent Application No. 10-2013-0117193, filed on Oct. 1, 2013, and all the benefits accruing therefrom under 35 U.S.C. §119, the contents of which are incorporated by reference herein in their entireties.

### 1. FIELD

Exemplary embodiments of the invention relate to a display apparatus. More particularly, exemplary embodiments of the invention relate to a display apparatus capable of decreasing a loss of light.

### 2. DESCRIPTION OF THE RELATED ART

A liquid crystal display (“LCD”) apparatus is widely used in a monitor, a laptop computer or mobile electronic devices because the LCD apparatus has low power consumption as well as being relatively thin and lightweight. The LCD apparatus displays images as arrangements of liquid crystals are changed according to an electric field which alters transmissivity of light through the liquid crystals. The LCD apparatus includes a display panel controlling the liquid crystals and a backlight assembly providing light to the display panel.

The LCD apparatus further includes a light-emitting diode (“LED”) assembly generating the light, a light guide plate modifying optical distribution of the light generated from the LED assembly, a reflection sheet reflecting the light leaked from the light guide plate, and an optical sheet improving optical properties of the light emitted through the light guide plate. Furthermore, the backlight assembly may include a lamp assembly, a bottom chassis receiving the reflection sheet and the optical sheet, a receiving member integrated with the bottom chassis, and a panel guide member fixing the receiving member and the display panel.

Also, the LCD apparatus may include a top chassis, a display panel, a mold frame, a middle chassis, and a fixing member for the light guide plate. The light guide plate is received in the bottom chassis by the fixing member. The mold frame is disposed on the light guide plate to guide edges of the light guide plate. An air gap may be defined between the display panel and the backlight assembly in order to reduce or effectively prevent electrical interference between components.

### SUMMARY

One or more exemplary embodiment of the invention provides a display apparatus capable of decreasing a loss of light.

One or more exemplary embodiment of the invention further provides display apparatus capable of decreasing the number of components and simplifying assembly of components.

According to an exemplary embodiment of the invention, a display apparatus includes a display panel which displays an image, a polarizing member including a first polarizing film on a lower surface of the display panel and a second polarizing film on an upper surface of the display panel, a light guide plate which receives the display panel and is adhered to the first polarizing film, and a reflecting sheet extending from a lower surface of the light guide plate to the upper surface of the display panel and covering the light guide plate and a portion of the display panel.

In an exemplary embodiment, the first polarizing film may include a light condensing layer which condenses a light from the light guide plate.

In an exemplary embodiment, the first polarizing film is adhered to the light guide plate by an optical clear adhesive.

In an exemplary embodiment, the display apparatus may further include a light source module adjacent to an end of the display panel.

In an exemplary embodiment, the light source module may include a flexible printed circuit extending in a length direction, and a plurality of the light sources on the flexible printed circuit.

In an exemplary embodiment, a cross-sectional thickness of the flexible printed circuit may be substantially the same or less than a cross-sectional thickness of the first polarizing film.

In an exemplary embodiment, the light sources may include light emitting diodes.

In an exemplary embodiment, the light guide plate may include a bonding portion which is adhered to the first polarizing film, and a side wall portion which protrudes from the bonding portion and guides a side surface of the display panel.

In an exemplary embodiment, the light guide plate may further include two longer sides opposite to each other and two shorter sides opposite to each other, and the side wall portion may be extended along the two longer sides and a first shorter side among the two shorter sides of the light guide plate.

In an exemplary embodiment, the display apparatus may further include a partial frame member which is adjacent to an edge of the light guide plate at a second shorter side opposite to the first shorter side of the light guide plate, and supports the display panel.

In an exemplary embodiment, the partial frame member may have a ‘U’ shape in a plan view and guides the light source module.

In an exemplary embodiment, the reflecting sheet may cover the light guide plate and the partial frame member.

In an exemplary embodiment, the display apparatus may further include a first light source module adjacent to a first end of the display panel, and a second light source module adjacent to a second end opposite to the first of the display panel and facing the first light source module.

In an exemplary embodiment, the first light source module and the second light source module may each include a flexible printed circuit extending in a length direction, and a plurality of the light sources on the flexible printed circuit.

In an exemplary embodiment, a cross-sectional thickness of the flexible printed circuit may be substantially the same as or less than a cross-sectional thickness of the first polarizing film.

In an exemplary embodiment, the light sources may include light emitting diodes.

In an exemplary embodiment, the light guide plate may include a bonding portion which is adhered to the first polarizing film, and a side wall portion which protrudes from the bonding portion and guides a side surface of the display panel.

In an exemplary embodiment, the light guide plate may further include two longer sides opposite to each other and two shorter sides opposite to each other, and the side wall portion may be extended along the two longer sides of the light guide plate.

In an exemplary embodiment, the display apparatus may further include a partial frame member which is respectively adjacent to the two shorter sides of the light guide plate and supports the display panel.

In an exemplary embodiment, the first polarizing film may be adhered to the light guide plate by an optical clear adhesive.

According to one or more exemplary embodiment, the first polarizing film may be adhered to the bonding portion of the light guide plate using an optical clear adhesive Thus, a space between the light guide plate and the display panel is not formed. Accordingly, a loss of a light may be decreased and a display quality of the display apparatus may be improved.

In addition, according to one or more exemplary embodiment, the reflecting sheet entirely covers other components of the display apparatus. Thus, a bottom chassis may be omitted and an overall cross-sectional thickness of the display apparatus may be reduced.

### BRIEF DESCRIPTION OF THE DRAWINGS

The above and other advantages and features of this disclosure will become more apparent by describing in further detail exemplary embodiments thereof in conjunction with the accompanying drawings, in which:

FIG. 1 is an exploded perspective view illustrating an exemplary embodiment of a display apparatus according to the invention;

FIG. 2 is a plan view illustrating an exemplary embodiment of a display apparatus according to the invention;

FIG. 3 is a cross-sectional view taken along line I-I′ of FIG. 2;

FIG. 4 is a perspective view illustrating an exemplary embodiment of a display panel of the display apparatus in FIG. 1;

FIG. 5 is a cross-sectional view taken along line II-II′ of FIG. 4;

FIG. 6 is a cross-sectional view taken along line III-III′ of FIG. 4;

FIG. 7 is a cross-sectional view illustrating an exemplary embodiment of a display panel engaged with a light source module according to the invention;

FIG. 8 is a perspective view illustrating an exemplary embodiment of a light guide plate according to the invention;

FIG. 9 is a plan view illustrating an exemplary embodiment a display panel engaged with the light guide plate according to the invention;

FIG. 10 is a cross-sectional view taken along line IV-IV′ of FIG. 9;

FIG. 11 is a cross-sectional view taken along line V-V′ of FIG. 9;

FIG. 12 is a plan view illustrating an exemplary embodiment a display panel engaged with a light guide plate and a partial frame member according to the invention;

FIG. 13 is a cross-sectional view taken along line VI-VI′ of FIG. 12;

FIG. 14 is a plan view illustrating an exemplary embodiment of a reflecting sheet according to the invention;

FIG. 15 is an exploded perspective view illustrating another exemplary embodiment of a display apparatus according to the invention;

FIG. 16 is a plan view illustrating another exemplary embodiment of a display apparatus according to the invention;

FIG. 17 is a cross-sectional view taken along line VII-VII′ of FIG. 16;

FIG. 18 is a perspective view illustrating a display panel of the display apparatus in FIG. 15;

FIG. 19 is a cross-sectional view taken along line VIII-VIII′ of FIG. 18;

FIG. 20 is a cross-sectional view illustrating another exemplary embodiment of a display panel engaged with a light source module according to the invention;

FIG. 21 is a perspective view illustrating another exemplary embodiment of a light guide plate according to the invention;

FIG. 22 is a plan view illustrating another exemplary embodiment a display panel engaged with a light guide plate according to the invention;

FIG. 23 is a cross-sectional view taken along line IX-IX′ of FIG. 22;

FIG. 24 is a plan view illustrating another exemplary embodiment a display panel engaged with a light guide plate and a partial frame member according to the invention; and

FIG. 25 is a cross-sectional view taken along line X-X′ of FIG. 24.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In a conventional display apparatus, an air gap may be defined between a display panel and a backlight assembly in order to reduce or effectively prevent electrical interference between components. Light from the backlight assembly travels to the display panel through the air gap. A refractive index of air is 1. However, a refractive index of the backlight assembly and the display panel is greater than the refractive index of air, so that reflection of the light occurs whenever the light travels through such components having different refractive index. Thus, a luminance of the display panel may be decreased.

Hereinafter, exemplary embodiments of the invention will be explained in detail with reference to the accompanying drawings.

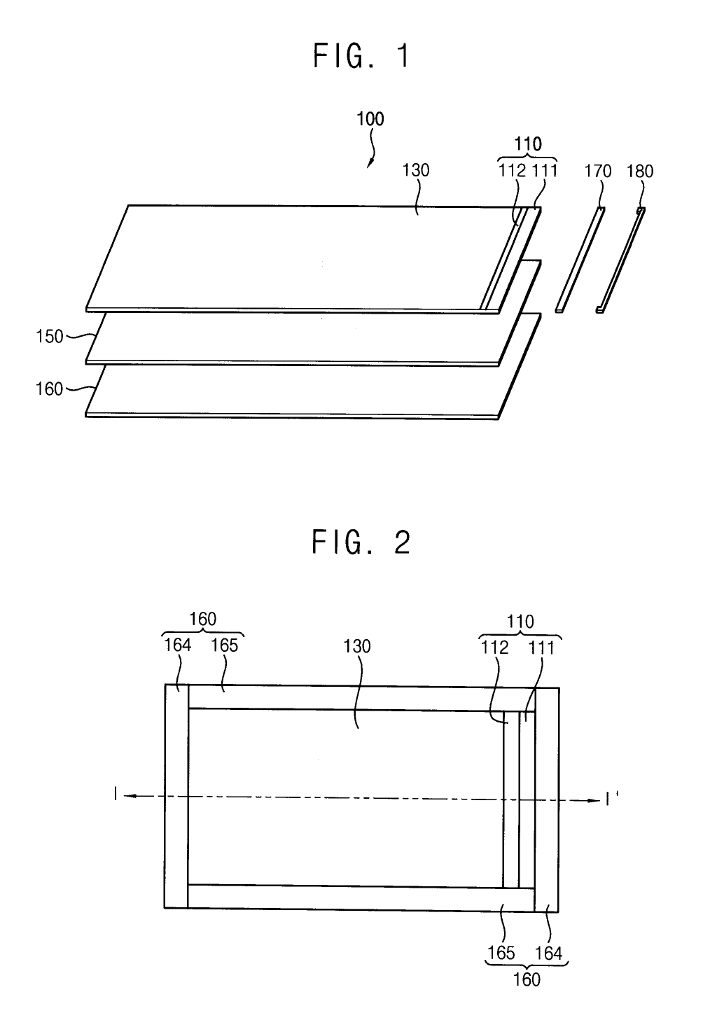

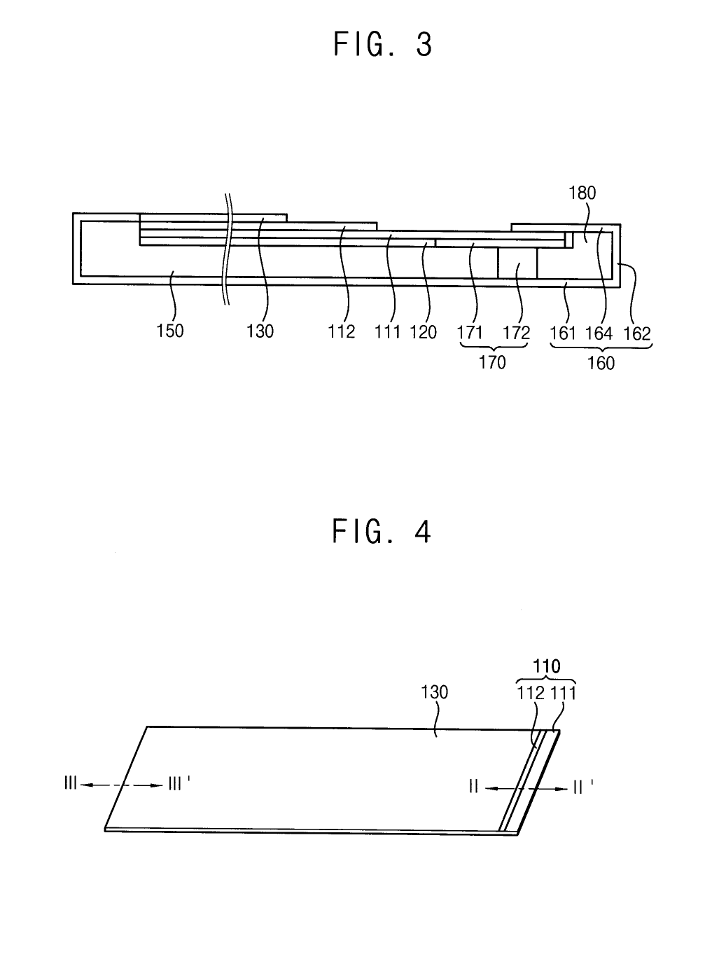

FIG. 1 is an exploded perspective view illustrating an exemplary embodiment of a display apparatus according to the invention. FIG. 2 is a plan view illustrating an exemplary embodiment of a display apparatus according to the invention. FIG. 3 is a cross-sectional view taken along line I-I′ of FIG. 2.

Referring to FIGS. 1 to 3, a display apparatus 100 includes a display panel 110, a light guide plate 150, a reflecting sheet 160, a light source module 170 and a partial frame member otherwise referred to as a molded member 180. The molded member 180 may be a single, unitary, indivisible member, but is not limited thereto. Additionally, the display apparatus 100 may further include a first polarizing film 120 disposed on a lower surface of the display panel 110 and a second polarizing film 130 disposed on an upper surface of the display panel 110.

The display panel 110 includes a lower substrate 111, an upper substrate 112 facing the lower substrate 111, and a liquid crystal layer (not shown) disposed between the lower substrate 111 and the upper substrate 112. The display panel 110 is disposed on the light guide plate 150 and an image is displayed by the display panel 110 using a light from the light guide plate 150.

The lower substrate 111 includes a plurality of thin film transistors (“TFTs”) disposed in a matrix shape on a base substrate of the lower substrate 111, as switching elements of the display panel 110. Each of the TFTs includes a source electrode and a drain electrode electrically connected to a gate line and a data line, respectively. The drain electrode is electrically connected to a pixel electrode including transparent conductive material.

The upper substrate 112 includes a common electrode including transparent conductive material. The upper substrate 112 may include a plurality of color filters disposed on a base substrate of the upper substrate 112.

The first polarizing film 120 is disposed on a lower surface of the display panel 110. In one exemplary embodiment, for example, the first polarizing film 120 may be adhered to a lower surface of the lower substrate 111. The first polarizing film 120 may improve an optical character and a luminance uniformity of a light emitted from the light guide plate 150. The first polarizing film 120 may have a first polarizing axis. The first polarizing film 120 may pass a light having a direction of the first polarizing axis.

The first polarizing film 120 may be a complex polarizing film. The complex polarizing film has a polarizing function and a condensing function. The first polarizing film 120 may have a light condensing layer. The light condensing layer may condense light emitted from the light guide plate 150. Thus, optical sheets disposed on the light guide plate may be omitted. Since optical sheets are omitted, the display apparatus 100 may have a relatively thin structure as compared to a conventional display apparatus including the separate optical sheets.

The first polarizing film 120 is adhered to the light guide plate 150. The first polarizing film 120 may be adhered to the light guide plate 150 using an adhesive. In one exemplary embodiment, for example, the adhesive attaching the first polarizing film 120 and the light guide plate 150 may be an optically clear adhesive (“OCA”).

The second polarizing film 130 is disposed on an upper surface of the display panel 110. In one exemplary embodiment, for example, the second polarizing film 130 may be adhered to an upper surface of the upper substrate 112. The second polarizing film 130 may have a second polarizing axis crossing the first polarizing axis. The second polarizing film 130 may pass a light having a direction of the second polarizing axis.

The light guide plate 150 is disposed under the display panel 110. The light guide plate 150 guides the light generated from the light source module 170 adjacent to a side of the light guide plate 150 (e.g., a light incident side), toward the display panel 110. The light guide plate 150 may include a light guide pattern and/or a reflection pattern to guide paths of the light. When the light emitted from a light incident surface of the light guide plate 150 reaches an upper surface or a lower surface of the light guide plate 150 with an angle larger than a critical angle, the light is totally reflected within the light guide plate 150 to be dispersed in the light guide plate 150. The light guide plate 150 may have a substantial plate shape. The light guide plate 150 may include a transparent material such as polymethyl methacrylate (“PMMA”) or polycarbonate (“PC”).

The light guide plate 150 may include a bonding portion 151 and a side wall portion 152 (refer to FIG. 8). The bonding portion 151 and the side wall portion 152 may define a receiving space in which other components are received. The bonding portion 151 may be adhered to the first polarizing film 120. The side wall portion 152 may be protruded from the bonding portion 151 and guide a side surface of the display panel 110. The first polarizing film 120 may be adhered to the bonding portion 151 of the light guide plate 150. Thus, a space between the light guide plate 150 and the display panel 110 is not formed when the display panel 110 is received in the light guide plate 150. In a conventional display apparatus, when a space between a light guide plate and a display panel is formed, a light may be reflected due to a difference of refractive index between air in the space and the light guide plate or between air in the space and the display panel. Since the light is reflected, the light may be lost and a quality of a display apparatus may be decreased. However, in one or more exemplary embodiment of a display apparatus according to the invention, a space is not formed between the light guide plate 150 and the display panel 110. Thus, a loss of a light may be decreased and a display quality of the display apparatus may be improved.

The light guide plate 150 may include a substantially rectangular planar shape having two longer sides opposite to each other and two shorter sides opposite to each other. The side wall portion 152 may be elongated along two longer side of the light guide plate 150 and one shorter side of the light guide plate 150. The light source module 170 is disposed at a shorter side of the light guide plate 150. Thus, the side wall portion 152 is not disposed along the side of the light guide plate 150 at which the light source module 170 is disposed.

Referring again to FIGS. 1 to 3, the light source module 170 is disposed facing the light incident surface of the light guide plate 150. The light source module 170 includes a flexible printed circuit 171 on which a plurality of light sources 172 generating light are mounted. The light sources 172 may include light emitting diodes (“LEDs”) generating the light by a power supplied from an outside power source (not shown). The LEDs are point light sources which may be arranged in a line on the flexible printed circuit 171. Also, the light sources 172 may include one or more of a red LED emitting red light, a green LED emitting green light, a blue LED emitting blue light and white LED emitting white light. In one exemplary embodiment, for example, the light sources 172 may include the red LED, the green LED and the blue LED, and white light generated from mixed red, green and blue light may be supplied to the light guide plate 150. The abovementioned number and the arrangement of the light sources and the light source module are exemplary and are not limited thereto.

The light source module 170 is disposed on the lower substrate 111 of the display panel 110. The light source module 170 may be disposed at an end of the lower substrate 111. In one exemplary embodiment, for example, the flexible printed circuit 171 may be disposed at an end of the first polarizing film 120 disposed on the lower substrate 111, such that the flexible printed circuit 171 may be substantially coplanar with and in a same layer as the first polarizing film 120. A cross-sectional thickness of the flexible printed circuit 171 may be substantially the same as a cross-sectional thickness of the first polarizing film 120, or a cross-sectional thickness of the flexible printed circuit 171 may be smaller than a cross-sectional thickness of the first polarizing film 120. The light sources 172 of the light source module 170 may be contacted with the incident surface of the light guide plate 150. While only one 172 is illustrated in the drawings, such number may refer to one light source or the collective light sources.

The molded member 180 may be disposed outside of the light source module 170. Referring to FIG. 8, the side wall portion 152 of the light guide plate 150 is not formed (e.g., omitted or excluded) along a side of the light guide plate 150 at which the light source module 170 is disposed. Thus, the molded member 180 supports the display panel 110 at the side of the light guide plate 150 at which the light source module 170 is disposed. The molded member 180 guides the light source module 170. The molded member 180 may have a ‘U’ shape in a plan view as illustrated in FIG. 1, to guide the light source module 170.

The reflecting sheet 160 is disposed on a lower surface of the light guide plate 150. The reflecting sheet 160 covers the display panel 110, the light source module 170, the molded member 180 and the light guide plate 150. The reflecting sheet 160 may be a single, unitary indivisible member which is bent from a lower surface of the light guide plate 150 to cover a side surface and an upper surface of the light guide plate 150 and a side surface and an upper surface of the molded member 180. In an exemplary embodiment of the display apparatus, the reflecting sheet 160 entirely covers other elements of the display apparatus. Thus, a bottom chassis may be omitted and an overall thickness of a display apparatus may be reduced.

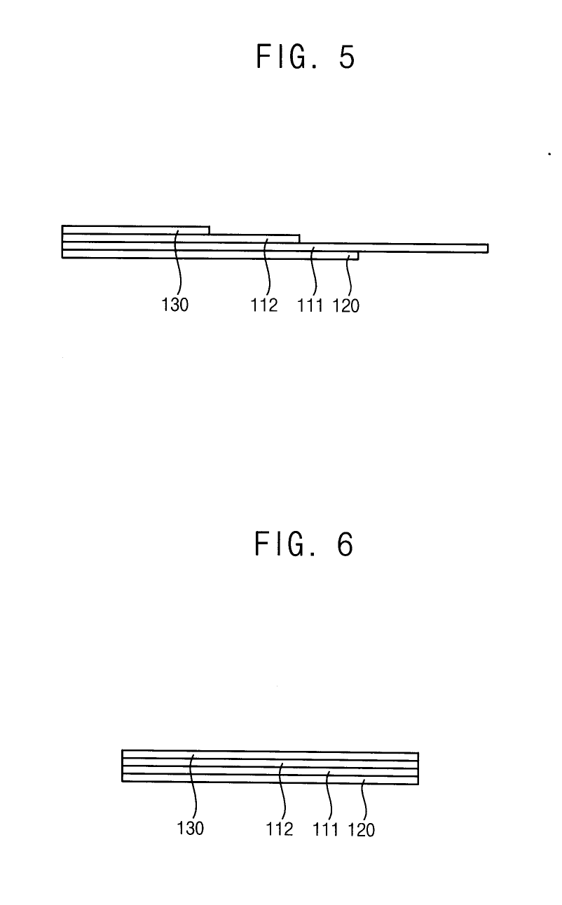

FIG. 4 is a perspective view illustrating an exemplary embodiment of a display panel of the display apparatus in FIG. 1. FIG. 5 is a cross-sectional view taken along line II-II′ of FIG. 4. FIG. 6 is a cross-sectional view taken along line III-III′ of FIG. 4.

Referring to FIGS. 3 to 6, a display panel 110 may include a lower substrate 111, and an upper substrate 112 facing the lower substrate 111. A first polarizing film 120 may be disposed on a lower surface of the lower substrate 111. The second polarizing film 130 may be disposed on an upper surface of the upper substrate 112.

One shorter side of the display panel 110 is illustrated in FIG. 5. The light source module 170 may be disposed at a first shorter side of the display panel 110. The light source module 170 may be disposed on the lower substrate 111. The lower substrate 111 may be larger than the upper substrate 112 in a plan view, to receive the light source module 170. A portion of the lower substrate 111 may be exposed by the upper substrate 112. The first polarizing film 120 may be disposed on a lower surface of the lower substrate 111. The first polarizing film 120 may be smaller than the lower substrate 111 in the plan view. When the first polarizing film 120 is adhered to the lower substrate 111, the lower surface of the lower substrate 111 may be partially exposed. The light source module 170 may be adhered to the partially exposed lower surface of the lower substrate 111.

A second shorter side opposite to the first shorter side of the display panel 110 is illustrated in FIG. 6. End surfaces of the lower substrate 111, the upper substrate 112, the first polarizing film 120 and the second polarizing film 130 are disposed in a line, such as to be coplanar with each other. The light source module 170 is not disposed at the second shorter side of the display panel 110. Thus, a space at which the light source module 170 is disposed is not necessary at the second shorter side. In addition, the light source module 170 is not disposed at longer sides of the display panel 110. Thus, the longer sides of the display panel 110 may have the same structures as the shorter side of the display panel 110 at which the light source module 170 is not disposed.

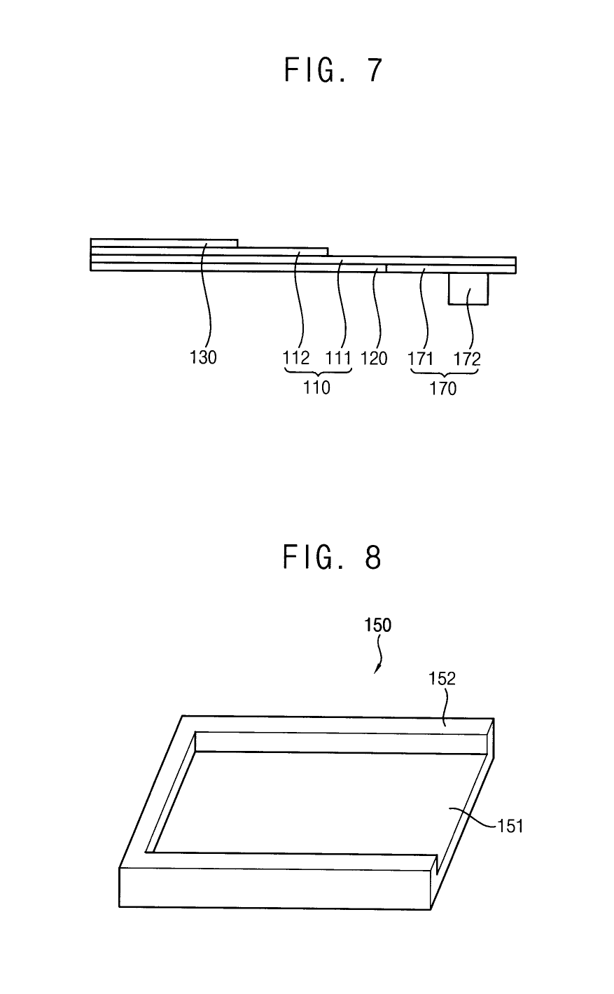

FIG. 7 is a cross-sectional view illustrating an exemplary embodiment of a display panel engaged with a light source module according to the invention.

Referring to FIG. 7, the first polarizing film 120 and the light source module 170 are disposed on a lower surface of the lower substrate 111. The second polarizing film 130 disposed on an upper surface of the upper substrate 112. The light source module 170 may include a flexible printed circuit 171 on which a plurality of light sources 172 generating light is mounted.

The lower substrate 111 may be larger than the upper substrate 112 in the plan view, to receive the light source module 170. The flexible printed circuit 171 of the light source module 170 may be disposed on a lower surface of the lower substrate 111. The flexible printed circuit 171 may be disposed adjacent to the first polarizing film 120.

FIG. 8 is a perspective view illustrating an exemplary embodiment of a light guide plate according to the invention.

Referring to FIG. 8, the light guide plate 150 may include the bonding portion 151 and the side wall portion 152. The bonding portion 151 may be adhered to the first polarizing film 120. The side wall portion 152 may be protruded from the bonding portion to guide a side surface of the display panel 110. The first polarizing film 120 may be adhered to the bonding portion 151 of the light guide plate 150. Thus, a space between the light guide plate 150 and the display panel 110 is not formed when the display panel 110 is received in the light guide plate 150. In a conventional display apparatus, when a space between a light guide plate and a display panel is formed, a light may be reflected due to a difference of refractive index between air in the space and the light guide plate or between air in the space and the display panel. Since the light is reflected, the light may be lost and a display quality of the display apparatus may be decreased. However, in one or more exemplary embodiment of a display apparatus according to the invention, a space between the light guide plate 150 and the display panel 110 is not formed. Thus, a loss of a light may be decreased and a display quality of the display apparatus may be improved.

The side wall portion 152 may be elongated along two longer side of the light guide plate 150 and one shorter side of the light guide plate 150. The light source module 170 is disposed at a shorter side of the light guide plate 150. Thus, the side wall portion 152 is not disposed along the shorter side of the light guide plate 150 at which the light source module 170 is disposed.

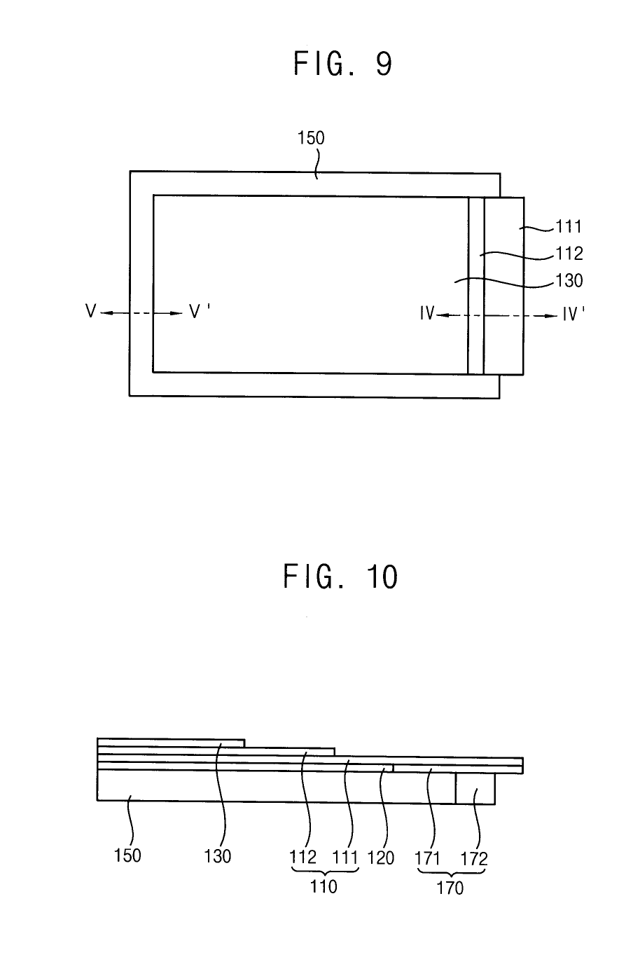

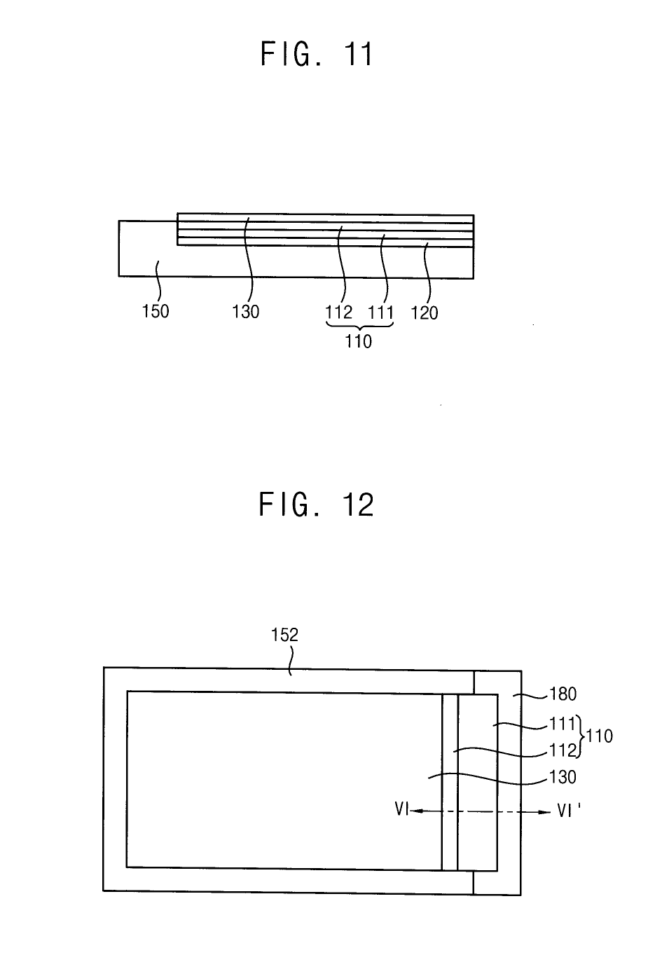

FIG. 9 is a plan view illustrating an exemplary embodiment a display panel engaged with a light guide plate according to the invention. FIG. 10 is a cross-sectional view taken along line IV-IV′ of FIG. 9. FIG. 11 is a cross-sectional view taken along line V-V′ of FIG. 9.

Referring to FIG. 9, a display panel 110 is disposed on the light guide plate 150. The side wall portion 152 is not disposed along a shorter side of the light guide plate 150 at which the light source module 170 is disposed.

Referring to FIG. 10, a display panel 110 on which the first polarizing film 120, the second polarizing film 130 and the light source module 170 are disposed, is disposed on the light guide plate 150. The light source module 170 may be contacted with the light guide plate 150. An outside area of the light source module 170 is not supported by the light guide plate 150.

The first polarizing film 120 is adhered to the light guide plate 150. The first polarizing film 120 may be adhered to the light guide plate 150 using an adhesive. In one exemplary embodiment, for example, the adhesive attaching the first polarizing film 120 and the light guide plate 150 may be an OCA.

According to the illustrated exemplary embodiment, the first polarizing film 120 may be adhered to the bonding portion 151 of the light guide plate 150 using an OCA. Thus, a space between the light guide plate 150 and the display panel 110 is not formed therebetween. In a conventional display apparatus, when a space between a light guide plate and a display panel is formed, a light may be reflected due to a difference of refractive index between air in the space and the light guide plate or between air in the space and the display panel. Since the light is reflected, the light may be lost and a display quality of the display apparatus may be decreased. However, in one or more exemplary embodiment of a display apparatus according to the invention, a space between the light guide plate 150 and the display panel 110 is not formed. Thus, a loss of a light may be decreased and a display quality of the display apparatus may be improved.

Referring to FIG. 11, a display panel 110 on which the first polarizing film 120, the second polarizing film 130 and the light source module 170 are disposed, is disposed on the light guide plate 150. A side surface of the display panel 110 is guided by the side wall portion 152 of the light guide plate 150. The light source module 170 is not disposed at a shorter side of the display panel 110. In addition, the light source module 170 is not disposed at longer sides of the display panel 110. Thus, the longer sides of the display panel 110 may have the same structures as the shorter side of the display panel 110 at which the light source module 170 is not disposed.

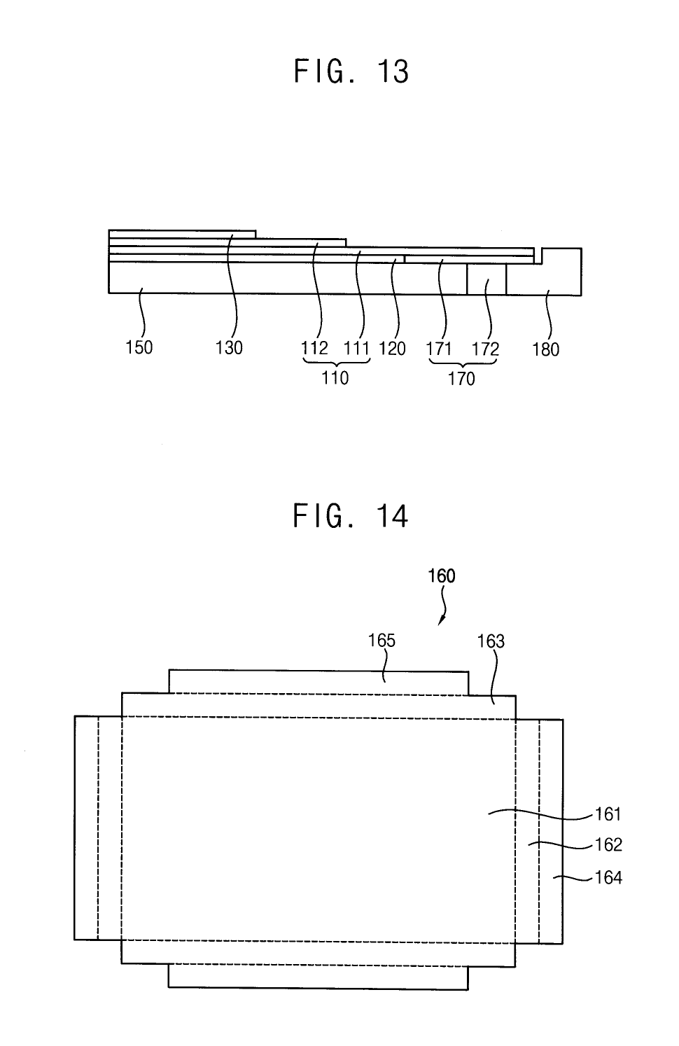

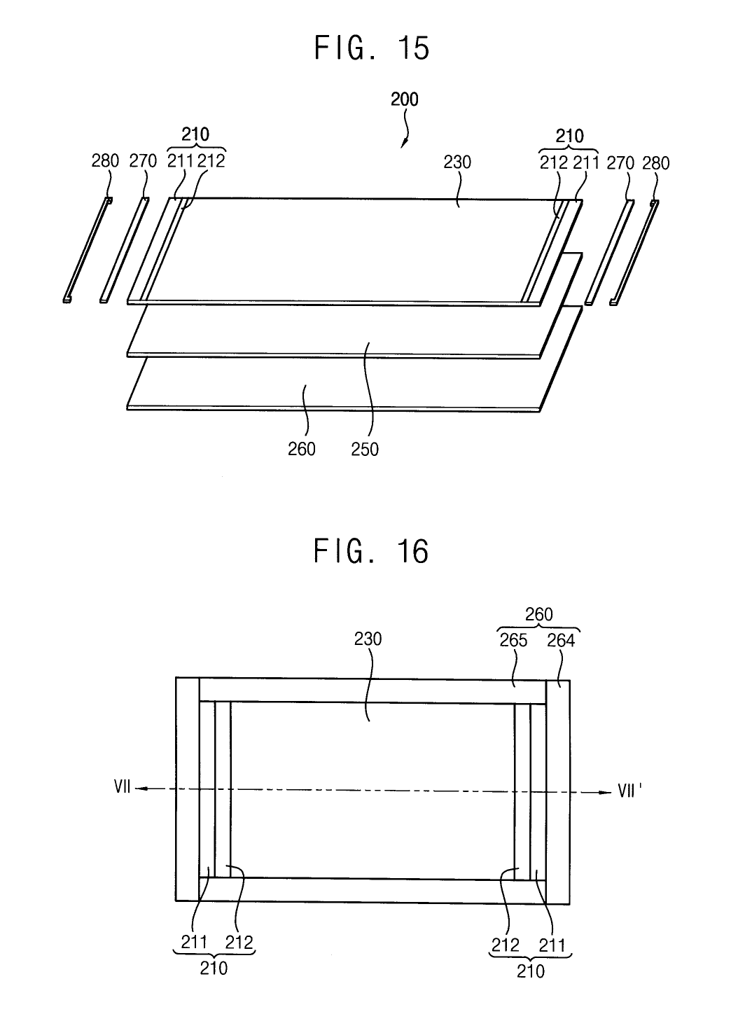

FIG. 12 is a plan view illustrating an exemplary embodiment a display panel engaged with the light guide plate and a molded member according to the invention. FIG. 13 is a cross-sectional view taken along line VI-VI′ of FIG. 12.

Referring to FIG. 12, the molded member 180 is engaged with the light guide plate 150 on which the display panel 110 is disposed. The molded member 180 is disposed at a shorter side of the display panel 110 at which light source module 170 is disposed. The shorter side of the display panel 110 at which light source module 170 is disposed is not supported by the light guide plate 150. The shorter side of the display panel 110 at which light source module 170 is disposed may be supported by the molded member 180.

The molded member 180 may have a ‘U’ shape in a plan view to guide the light source module 170.

Referring to FIG. 13, the molded member 180 is engaged to the light guide plate 150 on which the display panel 110 is disposed. The shorter side of the display panel 110 on which light source module 170 is disposed is not supported by the light guide plate 150. The shorter side of the display panel 110 on which light source module 170 is disposed may be supported by the molded member 180. The molded member 180 may be adhered to the light source 172 of the light source module 170. For example, the molded member 180 may be adhered to the light source 172 of the light source module 170 using a double-sided tape. The molded member 180 may have the same shape as the side wall portion 152 of the light guide plate 150 to support the display panel 110.

FIG. 14 is a planar view illustrating an exemplary embodiment of a reflecting sheet according to the invention.

Referring to FIG. 14, a reflecting sheet 160 includes a bottom portion 161, a first side surface portion 162, a second side surface portion 163, a first upper surface portion 164 and a second upper surface portion 165.

The reflecting sheet 160 may be a single, unitary, indivisible member which is bent to cover the molded member 180. The reflecting sheet 160 may be bent along the dotted lines shown in FIG. 14. The bottom portion 161 may cover a lower surface of the light guide plate 150. The first side surface portion 162 may cover a side surface of the light guide plate 150 and a side surface of the molded member 180. The second side surface portion 163 may cover a side surface of the light guide plate 150. The first upper surface portion 164 may cover an upper surface of the light guide plate 150 and an upper surface of the molded member 180. The second upper surface portion 165 may cover an upper surface of the light guide plate 150.

The first side surface portion 162, the second side surface portion 163, the first upper surface portion 164 and the second upper surface portion 165 are defined between bent portions of the reflecting sheet 160, so that the first upper surface portion 164 and the second upper surface portion 165 may be overlapped each other. However, the second upper surface portion 165 is shorter than the second side surface portion 163, so that the first upper surface portion 164 and the second upper surface portion 165 may be not overlapped each other. Alternately, the first upper surface portion 164 may be shorter than first side surface portion 162, and the second upper surface portion 165 may have a same length as the second side surface portion 163, so that the first upper surface portion 164 and the second upper surface portion 165 may be not overlapped each other.

As illustrated in FIG. 3, a display apparatus 100 according to the illustrated exemplary embodiment includes a display panel 110, a light guide plate 150, a reflecting sheet 160, a light source module 170 and a molded member 180. The first polarizing film 120 is disposed on a lower surface of the display panel 110. The second polarizing film 130 is disposed on an upper surface of the display panel 110. The light source module 170 is disposed on a lower surface of the display panel 110. The display panel 110 is disposed on the light guide plate 150. The reflecting sheet 160 covers the display panel 110, the light source module 170, the molded member 180 and the light guide plate 150.

The reflecting sheet 160 may include bent portions to cover a side surface and an upper surface of the light guide plate 150 and a side surface and an upper surface of the molded member 180.

According to the illustrated exemplary embodiments, the first polarizing film 120 may be adhered to the bonding portion 151 of the light guide plate 150 using an OCA. Thus, a space between the light guide plate 150 and the display panel 110 is not formed. In a conventional display apparatus, when a space between a light guide plate and a display panel is formed, a light may be reflected due to a difference of refractive index between air in the space and the light guide plate or between air in the space and the display panel. Since the light is reflected, the light may be lost and a display quality of the display apparatus may be decreased. However, in one or more exemplary embodiment of a display apparatus according to the invention, a space between the light guide plate 150 and the display panel 110 is not formed. Thus, a loss of a light may be decreased and a display quality of the display apparatus may be improved.

In addition, according to the illustrated exemplary embodiments, the reflecting sheet 160 entirely covers other components of the display apparatus. Thus, a bottom chassis may be omitted and an overall cross-sectional thickness of the display apparatus may be reduced.

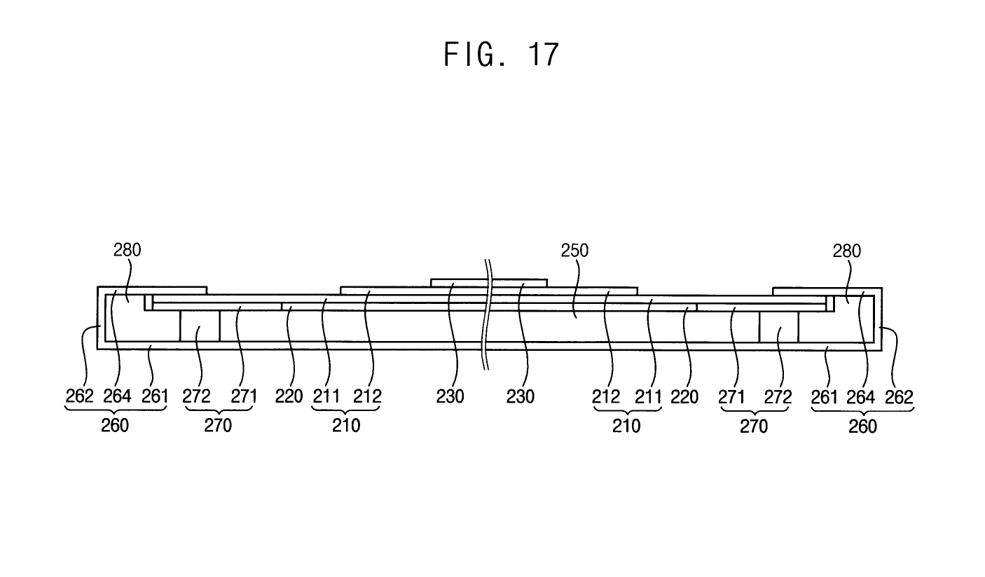

FIG. 15 is an exploded perspective view illustrating another exemplary embodiment of a display apparatus according to the invention. FIG. 16 is a plan view illustrating another exemplary embodiment of a display apparatus according to the invention. FIG. 17 is a cross-sectional view taken along line VII-VII′ of FIG. 16.

Referring to FIGS. 15 to 17, a display apparatus 200 includes a display panel 210, a light guide plate 250, a reflecting sheet 260, a light source module 270 and a molded member 280. Additionally, the display apparatus 200 may further include a first polarizing film 220 disposed on a lower surface of the display panel 210 and a second polarizing film 230 disposed on an upper surface of the display panel 210. Referring to FIG. 16, a reflecting sheet 260 includes a bottom portion 261, a first side surface portion 262, a second side surface portion, a first upper surface portion 264 and a second upper surface portion 265.

The display panel 210 includes a lower substrate 211, an upper substrate 212 facing the lower substrate 211, and a liquid crystal layer (not shown) disposed between the lower substrate 211 and the upper substrate 212. The display panel 210 is disposed on the light guide plate 250 and an image is displayed by the display panel 210 using a light from the light guide plate 250.

The lower substrate 211 includes a plurality of “TFTs” disposed in a matrix shape on a base substrate of the lower substrate 211, as switching elements of the display panel 210. Each of the TFTs includes a source electrode and a drain electrode electrically connected to a gate line and a data line, respectively. The drain electrode is electrically connected to a pixel electrode including transparent conductive material.

The upper substrate 212 includes a common electrode including transparent conductive material. The upper substrate 212 may include a plurality of color filters disposed on a base substrate of the upper substrate 212.

The first polarizing film 220 is disposed on a lower surface of the display panel 210. In one exemplary embodiment, for example, the first polarizing film 220 may be adhered to a lower surface of the lower substrate 211. The first polarizing film 220 may improve an optical character and a luminance uniformity of a light emitted from the light guide plate 250. The first polarizing film 220 may have a first polarizing axis. The first polarizing film 220 may pass a light having a direction of the first polarizing axis.

The first polarizing film 220 may be a complex polarizing film. The complex polarizing film has a polarizing function and a condensing function. The first polarizing film 220 may have a light condensing layer. The light condensing layer may condense light from the light guide plate 250. Thus, optical sheets disposed on the light guide plate may be omitted. Since optical sheets are omitted, the display apparatus may have a thin structure as compared to a conventional display apparatus including the separate optical sheets.

The first polarizing film 220 is adhered to the light guide plate 250. The first polarizing film 220 may be adhered to the light guide plate 250 using an adhesive. In one exemplary embodiment, for example, the adhesive attaching the first polarizing film 220 and the light guide plate 250 may be an OCA.

The second polarizing film 230 is disposed on an upper surface of the display panel 210. In one exemplary embodiment, for example, the second polarizing film 230 may be adhered to an upper surface of the upper substrate 212. The second polarizing film 230 may have a second polarizing axis crossing the first polarizing axis. The second polarizing film 230 may pass a light having a direction of the second polarizing axis.

The light guide plate 250 is disposed under the display panel 210. The light guide plate 250 guides the light generated from the light source module 270 adjacent to a side of the light guide plate 250, toward the display panel 210. The light guide plate 250 may include a light guide pattern and/or a reflection pattern to guide paths of the light. When the light emitted from a light incident surface of the light guide plate 250 reaches an upper surface or a lower surface of the light guide plate 250 with an angle larger than a critical angle, the light is totally reflected within the light guide plate 250 to be distributed in the light guide plate 250. The light guide plate 250 may have a plate shape. The light guide plate 250 may include a transparent material such as PMMA or PC.

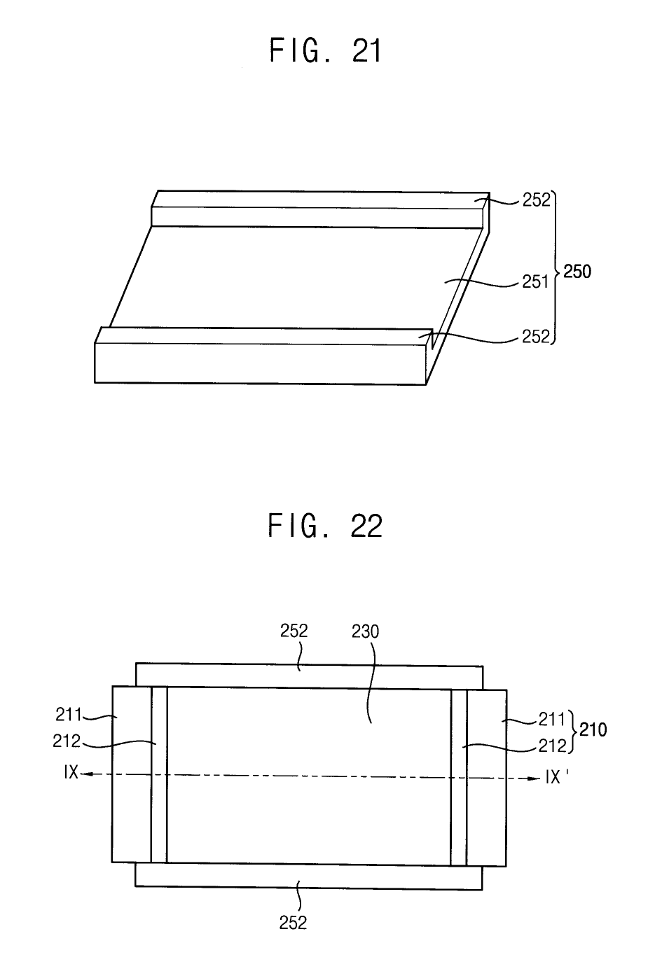

Referring to FIG. 21, the light guide plate 250 may include a bonding portion 251 and a side wall portion 252. The bonding portion 251 may be adhered to the first polarizing film 220. The side wall portion 252 may be protruded from the bonding portion to guide a side surface of the display panel 210. The first polarizing film 220 may be adhered to the bonding portion 251 of the light guide plate 250. Thus, a space between the light guide plate 250 and the display panel 210 is not formed. In a conventional display apparatus, when a space between a light guide plate and a display panel is formed, a light may be reflected due to a difference of refractive between air in the space and the light guide plate or between air in the space and the display panel. Since the light is reflected, the light may be lost and a display quality of a display apparatus may be decreased. However, in one or more exemplary embodiment of the display apparatus according to the invention, a space between the light guide plate 250 and the display panel 210 is not formed. Thus, a loss of a light may be decreased and a display quality of the display apparatus may be improved.

The side wall portion 252 may be elongated along two longer side of the light guide plate 250. The light source module 270 is disposed at both of two shorter sides of the light guide plate 250. Thus, the side wall portion 252 is not disposed along the sides of the light guide plate 250 at which the light source module 270 is disposed.

Each light source module 270 is disposed facing a light incident surface of the light guide plate 250. The light source module 270 includes a flexible printed circuit 271 on which a plurality of light sources 272 generating light are mounted. The light sources 272 may include “LEDs” generating the light by a power supplied from an outside power source (not shown). The LEDs may be point light sources which are arranged in a line on the flexible printed circuit 271. Also, the light sources 272 may include one or more of a red LED emitting red light, a green LED emitting green light, a blue LED emitting blue light and white LED emitting white light. In one exemplary embodiment, for example, the light sources 272 may include the red LED, the green LED and the blue LED, and white light from a mixture of the red, green, and blue light may be supplied to the light guide plate 250. The abovementioned number and the arrangement of the light sources and the light source module are exemplary and are not limited thereto.

The light source module 270 is disposed on the lower substrate 211 of the display panel 210. The light source module 270 may be disposed at opposing ends of the lower substrate 211. In one exemplary embodiment, for example, the flexible printed circuit 271 may be disposed at an end of the first polarizing film 220 disposed on the lower substrate 211. A cross-sectional thickness of the flexible printed circuit 271 is substantially the same as a cross-sectional thickness of the first polarizing film 220, or a cross-sectional thickness of the flexible printed circuit 271 is smaller than a cross-sectional thickness of the first polarizing film 220. The light source 272 of the light source module 270 may be contacted with the incident surface of the light guide plate 250.

The molded member 280 may be disposed outside of the light source module 270. The side wall portion 252 of the light guide plate 250 is not disposed along two shorter sides of the light guide plate 250 at which the light source module 270 is disposed. Thus, the molded member 280 supports the display panel 210 at the two shorter sides of the light guide plate 250 at which the light source module 270 is disposed. The molded member 280 guides the light source module 270. The molded member 280 may have a ‘U’ shape in a plan view to guide the light source module 270.

The reflecting sheet 260 is disposed on a lower surface of the light guide plate 250. The reflecting sheet 260 covers the display panel 210, the light source module 270, the molded member 280 and the light guide plate 250. The reflecting sheet 260 may be bent to cover a side surface and an upper surface of the light guide plate 250 and a side surface and an upper surface of the molded member 280. The exemplary embodiment of the reflecting sheet 260 according to the invention entirely other components of a display apparatus. Thus, a bottom chassis may be omitted and an overall thickness of a display apparatus may be reduced.

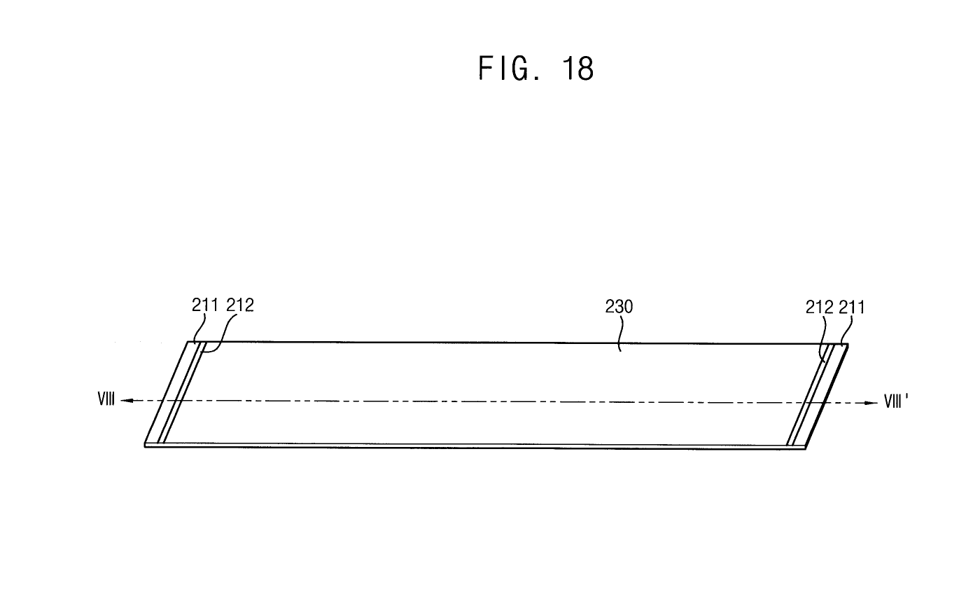

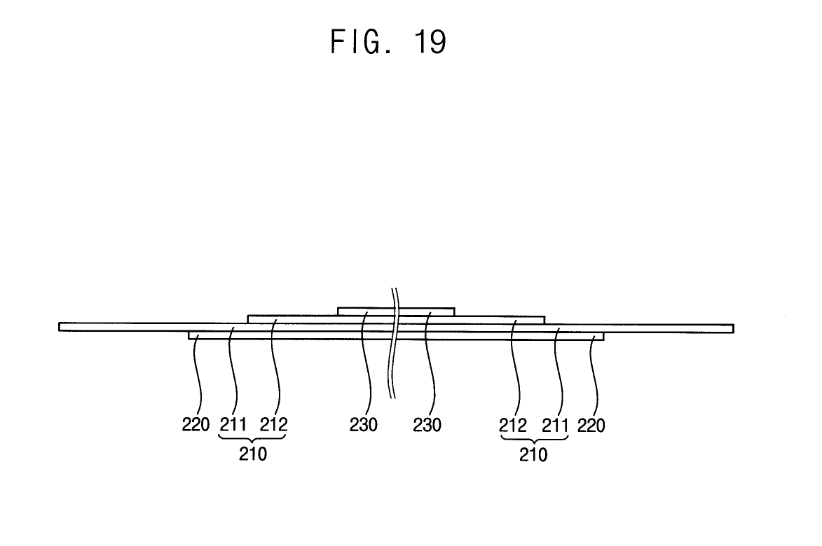

FIG. 18 is a perspective view illustrating an exemplary embodiment of a display panel of the display apparatus in FIG. 15. FIG. 19 is a cross-sectional view taken along line VIII-VIII′ of FIG. 18.

Referring to FIGS. 15, 18 and 19, a display panel 210 includes a lower substrate 211, and an upper substrate 212 facing the lower substrate 211. A first polarizing film 220 may be disposed on a lower surface of the lower substrate 211. The second polarizing film 230 may be disposed on an upper surface of the upper substrate 212.

The light source module 270 may be disposed at two shorter sides of the display panel 210. The light source module 270 may be disposed on the lower substrate 211. The lower substrate 211 may be larger than the upper substrate 212 to receive the light source module 270. The first polarizing film 220 may be disposed on a lower surface of the lower substrate 211. The first polarizing film 220 may be smaller than the lower substrate 211. When the first polarizing film 220 is adhered to the lower substrate 211, the lower surface of the lower substrate 211 may be partially exposed. The light source module 270 may be adhered to the partially exposed lower surface of the lower substrate 211. In the illustrated exemplary embodiment, the light source module 270 is disposed at two opposing shorter sides of the display panel 210, so that two shorter sides of the display panel 210 may have a same structure.

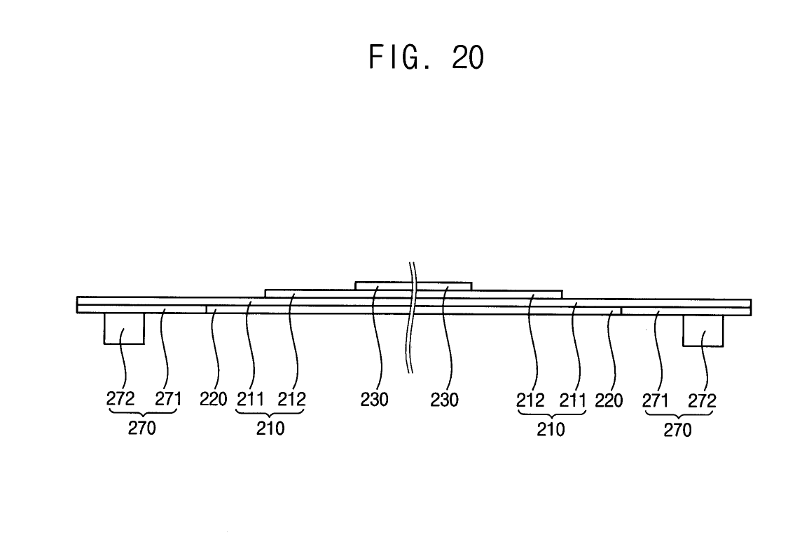

FIG. 20 is a cross-sectional view illustrating another exemplary embodiment of a display panel engaged with a light source module according to the invention.

Referring to FIG. 20, the first polarizing film 220 and the light source module 270 are disposed on a lower surface of the lower substrate 211. The second polarizing film 230 is disposed on an upper surface of the upper substrate 212. The light source module 270 may include a flexible printed circuit 271 on which a plurality of light sources 272 generating light are mounted.

The lower substrate 211 may be larger than the upper substrate 212 to receive the light source module 270. The flexible printed circuit 271 of the light source module 270 may be disposed on a lower surface of the lower substrate 211. The flexible printed circuit 271 may be disposed adjacent to the first polarizing film 220. In the illustrated exemplary embodiment, the light source module 270 is disposed at two opposing shorter sides of the display panel 210, so that two shorter sides of the display panel 210 may have a same structure.

FIG. 21 is a perspective view illustrating another exemplary embodiment of a light guide plate according to the invention.

Referring to FIG. 21, the light guide plate 250 may include the bonding portion 251 and the side wall portion 252. The bonding portion 251 may be adhered to the first polarizing film 220. The side wall portion 252 may be protruded from the bonding portion 251 to guide a side surface of the display panel 210. The first polarizing film 220 may be adhered to the bonding portion 251 of the light guide plate 250. Thus, a space between the light guide plate 250 and the display panel 210 is not formed. In a conventional display apparatus, when a space between a light guide plate and a display panel is formed, a light may be reflected due to a difference of refractive index between air in the space and the light guide plate or between air in the space and the display panel. Since the light is reflected, the light may be lost and a display quality of the display apparatus may be decreased. However, in one or more exemplary embodiment of a display apparatus according to the invention, a space between the light guide plate 250 and the display panel 210 is not formed. Thus, a loss of a light may be decreased and a display quality of the display apparatus may be improved.

The side wall portion 252 may be elongated along two longer sides of the light guide plate 250. The light source module 270 is disposed at two shorter sides of the light guide plate 250. Thus, the side wall portion 252 is not disposed along two shorter sides of the light guide plate 250 at which the light source module 270 is disposed.

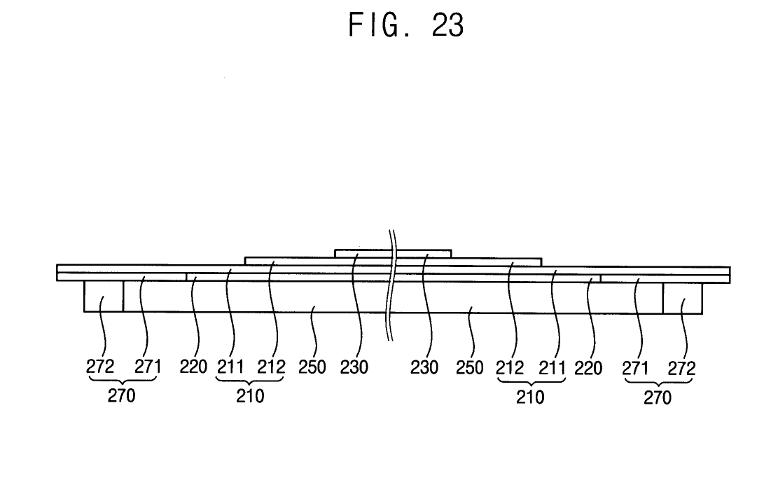

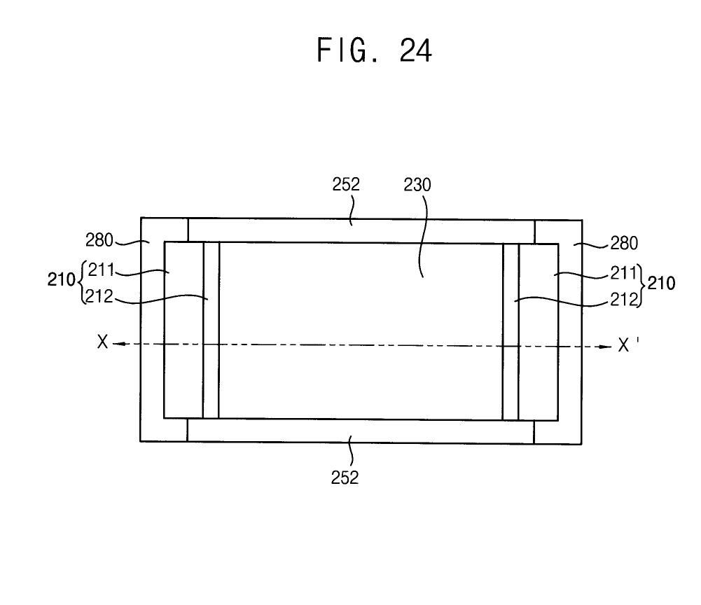

FIG. 22 is a plan view illustrating another exemplary embodiment a display panel engaged with a light guide plate according to the invention. FIG. 23 is a cross-sectional view taken along line IX-IX′ of FIG. 22.

Referring to FIG. 22, a display panel 210 is disposed on the light guide plate 250. The side wall portion 252 is not disposed along two shorter sides of the light guide plate 250 at which the light source module 270 is disposed. In the illustrated exemplary embodiment, the light source module 270 is disposed at two shorter sides of the display panel 210, so that two shorter sides of the display panel 210 may have a same structure.

Referring to FIG. 23, a display panel 210 on which the first polarizing film 220, the second polarizing film 230 and the light source module 270 are disposed is disposed on the light guide plate 250. The light source module 270 may be contacted with the light guide plate 250. An outside area of the light source module 270 is not supported by the light guide plate 250.

The first polarizing film 220 is adhered to the light guide plate 250. The first polarizing film 220 may be adhered to the light guide plate 250 using an adhesive. In one exemplary embodiment, for example, the adhesive attaching the first polarizing film 220 and the light guide plate 250 may be an OCA.

According to the illustrated exemplary embodiment, the first polarizing film 220 may be adhered to the bonding portion 251 of the light guide plate 250 using an OCA. Thus, a space between the light guide plate 250 and the display panel 210 is not formed. In a conventional display apparatus, when a space between a light guide plate and a display panel is formed, a light may be reflected due to a difference of refractive index between air in the space and the light guide plate or between air in the space and the display panel. Since the light is reflected, the light may be lost and a display quality of the display apparatus may be decreased. However, in one or more exemplary embodiment of a display apparatus according to the invention, a space between the light guide plate 250 and the display panel 210 is not formed. Thus, a loss of a light may be decreased and a display quality of the display apparatus may be improved.

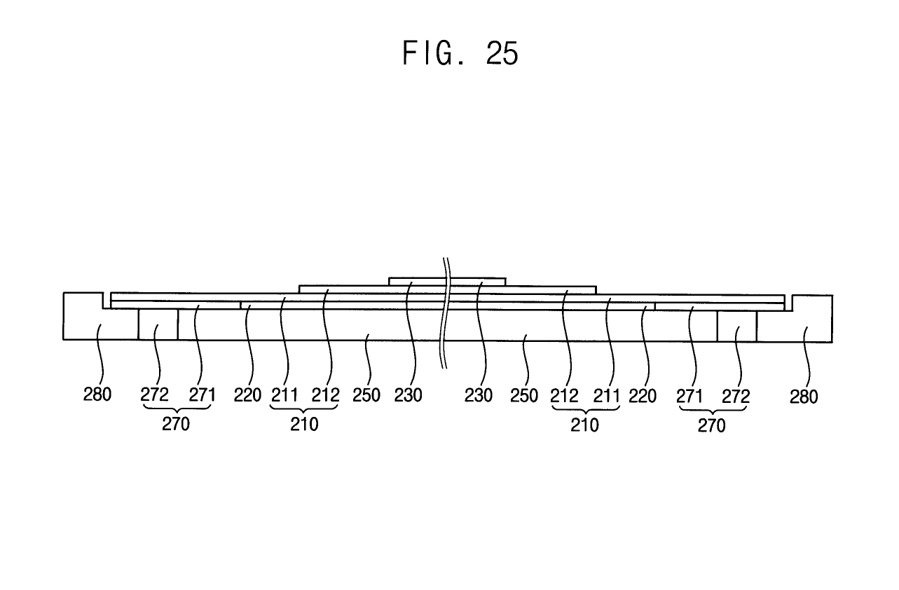

FIG. 24 is a plan view illustrating another exemplary embodiment a display panel engaged with a light guide plate and a molded member according to the invention. FIG. 25 is a cross-sectional view taken along line X-X′ of FIG. 24.

Referring to FIG. 24, the molded member 280 is engaged to the light guide plate 250 on which the display panel 210 is disposed. The molded member 280 is disposed at two shorter sides of the display panel 210 at which a light source module 270 is disposed. Two shorter sides of the display panel 210 at which a light source module 270 is disposed is not supported by the light guide plate 250. Two shorter sides of the display panel 210 at which a light source module 270 is disposed may be supported by the molded member 280.

The molded member 280 may have a ‘U’ shape in a plan view to guide the light source module 270.

Referring to FIG. 25, the molded member 280 is engaged with the light guide plate 250 on which the display panel 210 is disposed. Two shorter sides of the display panel 210 on which a light source module 270 is disposed is not supported by the light guide plate 250. Two shorter sides of the display panel 210 on which a light source module 270 is disposed may be supported by the molded member 280. The molded member 280 may be adhered to the light source 272 of the light source module 270. In one exemplary embodiment, for example, the molded member 280 may be adhered to the light source 272 of the light source module 270 using a double-sided tape. The molded member 280 may have substantially the same shape as the side wall portion 252 of the light guide plate 250 to support the display panel 210.

As illustrated in FIG. 17, a display apparatus 200 according to the illustrated exemplary embodiment includes a display panel 210, a light guide plate 250, a reflecting sheet 260, a light source module 270 and a molded member 280. The first polarizing film 220 is disposed on a lower surface of the display panel 210. The second polarizing film 230 is disposed on an upper surface of the display panel 210. The light source module 270 is disposed on a lower surface of the display panel 210. The display panel 210 is disposed on light guide plate 250. The reflecting sheet 260 covers the display panel 210, the light source module 270, the molded member 280 and the light guide plate 250.

The reflecting sheet 260 may be bent to cover a side surface and an upper surface of the light guide plate 250 and a side surface and an upper surface of the molded member 280.

According to one or more exemplary embodiment, the first polarizing film may be adhered to the bonding portion of the light guide plate using an OCA. Thus, a space between the light guide plate and the display panel is not formed. Accordingly, a loss of a light may be decreased and a display quality of the display apparatus may be improved.

In addition, according to one or more exemplary embodiment, the reflecting sheet entirely covers other components of the display apparatus. Thus, a bottom chassis may be omitted and an overall cross-sectional thickness of the display apparatus may be reduced.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifies to the disclosed exemplary embodiments, as well as other exemplary embodiments, are intended to be included within the scope of the appended claims. The invention is defined by the following claims, with equivalents of the claims to be included therein.

What is claimed is:

1. A display apparatus comprising:
a display panel which displays an image;
a polarizing member comprising a first polarizing film on a lower surface of the display panel and a second polarizing film on an upper surface of the display panel;
a light guide plate which receives the display panel and is adhered to the first polarizing film; and
a reflecting sheet extending from a lower surface of the light guide plate to the upper surface of the display panel and covering the light guide plate and a portion of the display panel.

2. The display apparatus of claim 1, wherein the first polarizing film comprises a light condensing layer which condenses a light from the light guide plate.

3. The display apparatus of claim 1, wherein the first polarizing film is adhered to the light guide plate by an optical clear adhesive.

4. The display apparatus of claim 1, further comprising
a light source module adjacent to an end of the display panel.

5. The display apparatus of claim 4, wherein the light source module comprises:
a flexible printed circuit extending in a length direction; and
a plurality of light sources on the flexible printed circuit.

6. The display apparatus of claim 5, wherein a cross-sectional thickness of the flexible printed circuit is substantially the same as or less than a cross-sectional thickness of the first polarizing film.

7. The display apparatus of claim 5, wherein the plurality of light sources comprises light emitting diodes.

8. The display apparatus of claim 4, wherein the light guide plate comprises:
a bonding portion which is adhered to the first polarizing film; and
a side wall portion which protrudes from the bonding portion and faces a side surface of the display panel.

9. The display apparatus of claim 8, wherein
the light guide plate further comprises two longer sides opposite to each other and two shorter sides opposite to each other, and
the side wall portion is extended along the two longer sides and a first shorter side among the two shorter sides of the light guide plate.

10. The display apparatus of claim 9, further comprising:
a partial frame member which is adjacent to an edge of the light guide plate at a second shorter side opposite to the first shorter side of the light guide plate, and supports the display panel thereon.

11. The display apparatus of claim 10, wherein the partial frame member has a ‘U’ shape in a plan view and guides the light source module.

12. The display apparatus of claim 11, wherein the reflecting sheet covers the light guide plate and the partial frame member.

13. The display apparatus of claim 1, further comprising
a first light source module adjacent to a first end of the display panel; and
a second light source module adjacent to a second end opposite to the first end of the display panel, and facing the first light source module.

14. The display apparatus of claim 13, wherein the first light source module and the second light source module each comprises:
a flexible printed circuit extending in a length direction; and
a plurality of light sources on the flexible printed circuit.

15. The display apparatus of claim 14, wherein a cross-sectional thickness of the flexible printed circuit is substantially the same as or less than a cross-sectional thickness of the first polarizing film.

16. The display apparatus of claim 15, wherein the plurality of light sources comprises light emitting diodes.

17. The display apparatus of claim 13, wherein the light guide plate comprises:
a bonding portion which is adhered to the first polarizing film; and
a side wall portion which protrudes from the bonding portion and guides a side surface of the display panel.

18. The display apparatus of claim 17, wherein
the light guide plate further comprises two longer sides opposite to each other and two shorter sides opposite to each other, and
the side wall portion is extended along the two longer sides of the light guide plate.

19. The display apparatus of claim 17, further comprising:
a plurality of partial frame members which is respectively adjacent to the two shorter sides of the light guide plate, and supports the display panel.

20. The display apparatus of claim 13, wherein the first polarizing film is adhered to the light guide plate by an optical clear adhesive.
